(19) United States
(12) Patent Application Publication
(10) Pub. No.: US 2023/0237544 A1
(43) Pub. Date: Jul. 27, 2023

(54) PRICE CALCULATION DEVICE

(71) Applicant: NEC Corporation, Minato-ku, Tokyo (JP)

(72) Inventors: Yukiko TABUCHI, Tokyo (JP); Takashi NAGATA, Tokyo (JP); Akihiro NAKAMURA, Tokyo (JP)

(73) Assignee: NEC Corporation, Minato-ku, Tokyo (JP)

(21) Appl. No.: 17/918,965

(22) PCT Filed: Apr. 20, 2020
(86) PCT No.: PCT/JP2020/017029

§ 371 Date: Oct. 14, 2022

(51) Int. Cl. G06Q 30/0283

(52) U.S. Cl. CPC G06Q 30/0283

(57) ABSTRACT

A price calculation device 200 includes a condition information acquisition unit 221 that acquires condition information representing the condition of a user who is receiving a service, a situation information acquisition unit 222 that acquires situation information representing the situation of the user, and a calculation unit 223 that calculates the price of the service on the basis of the condition information acquired by the condition information acquisition unit 221 and the situation information acquired by the situation information acquisition unit 222.

### TECHNICAL FIELD

The present invention relates to a price calculation device, a price calculation method, and a storage medium.

### BACKGROUND ART

Art of reflecting consumer evaluation to determination of prices of goods and services has been known.

As one of such art, Patent Literature 1 has been known. Patent Literature 1 describes a charge presentation device including a price condition presentation unit, a satisfaction measurement unit, and a charge calculation unit. According to Patent Literature 1, when a consumer receives a product based on a condition presented by the price condition presentation unit, the satisfaction measurement unit measures the satisfaction with respect to the product of the consumer who receives the product. Then, the charge calculation unit calculates and presents the charge (price) of the product on the basis of the condition and the satisfaction.
Patent Literature 1: JP 2015-130045 A

### SUMMARY

Depending on the service content to be provided, a period of time for providing a service may include a period of time in which the service is not actually performed such as a break time, a moving time, and the time for explanation. In such a case, when the price is calculated by simply performing measurement of satisfaction as described in Patent Literature 1, the accuracy of satisfaction may be lowered due to a cause other than the service content. This may make appropriate price estimation difficult.

In view of the above, an object of the present invention is to provide a price calculation device, a price calculation method, and a storage medium capable of solving a problem that it may be difficult to perform appropriate price estimation.

In order to achieve such an object, a price calculation device according to one aspect of the present disclosure is configured to include

a condition information acquisition unit that acquires condition information representing a condition of a user who is receiving a service,

a situation information acquisition unit that acquires situation information representing a situation of the user, and

a calculation unit that calculates a price of the service on the basis of the condition information acquired by the condition information acquisition unit and the situation information acquired by the situation information acquisition unit.

Further, a price calculation method according to another aspect of the present disclosure is configured to include, by a price calculation device,

acquiring condition information representing a condition of a user who is receiving a service,

acquiring situation information representing a situation of the user, and

calculating a price of the service on the basis of the acquired condition information and the acquired situation information.

Further, a storage medium according to another aspect of the present disclosure is a computer-readable medium storing thereon a program for implementing, on a price calculation device,

a condition information acquisition unit that acquires condition information representing a condition of a user who is receiving a service

a situation information acquisition unit that acquires situation information representing a situation of the user and

a calculation unit that calculates a price of the service on the basis of the condition information acquired by the condition information acquisition unit and the situation information acquired by the situation information acquisition unit.

With the configurations described above, it is possible to provide a price calculation device, a price calculation method, and a storage medium capable of solving a problem that it may be difficult to perform appropriate price estimation.

### BRIEF DESCRIPTION OF DRAWINGS

FIG. 1 illustrates an exemplary configuration of a price calculation system according to a first exemplary embodiment of the present disclosure.

FIG. 2 is a block diagram illustrating an exemplary configuration of the price calculation device illustrated in FIG. 1.

FIG. 3 is a diagram for explaining an example of situation information.

FIG. 4 is a diagram for explaining an example of satisfaction information.

FIG. 5 is a diagram for explaining exemplary processing performed by a price estimation unit.

FIG. 6 is a diagram illustrating an exemplary output by an output unit.

FIG. 7 is a block diagram illustrating an exemplary configuration of a wearable sensor.

FIG. 8 is a block diagram illustrating an exemplary configuration of a smartphone.

FIG. 9 is a flowchart illustrating an exemplary operation of a price calculation device according to the first exemplary embodiment of the present disclosure.

FIG. 10 is a block diagram illustrating another exemplary configuration of a price calculation device.

FIG. 11 is a block diagram illustrating another exemplary configuration of a price calculation device.

FIG. 12 illustrates another exemplary configuration of a price calculation system.

FIG. 13 illustrates an exemplary hardware configuration of a price calculation device according to a second exemplary embodiment of the present disclosure.

FIG. 14 is a block diagram illustrating an exemplary configuration of a price calculation device according to the second exemplary embodiment of the present disclosure.

### EXEMPLARY EMBODIMENTS

### First Exemplary Embodiment

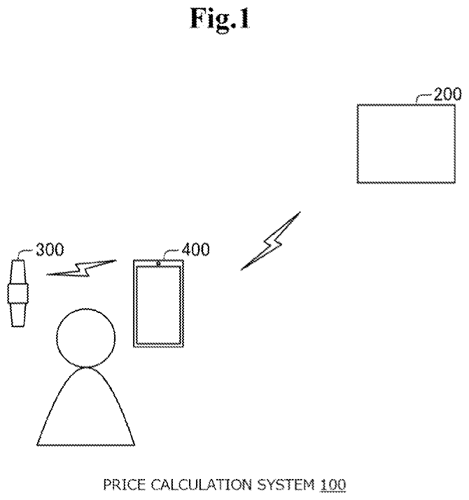

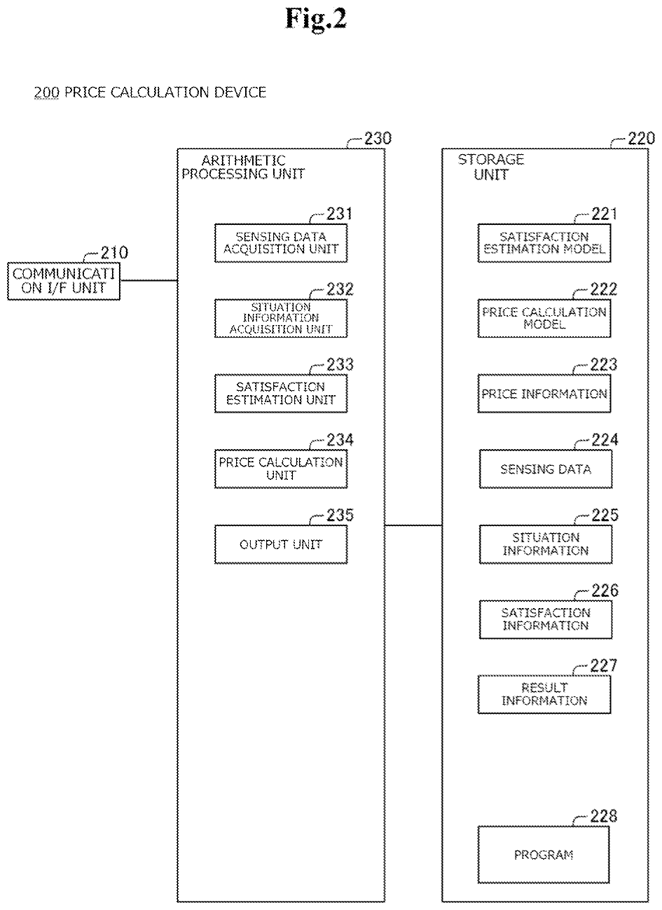

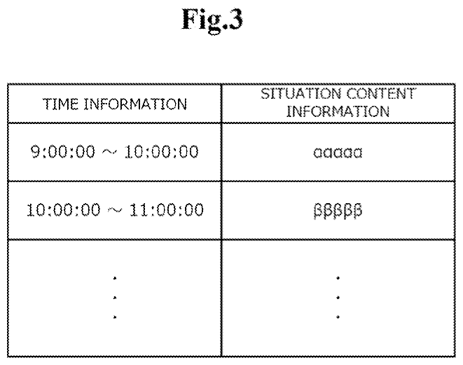

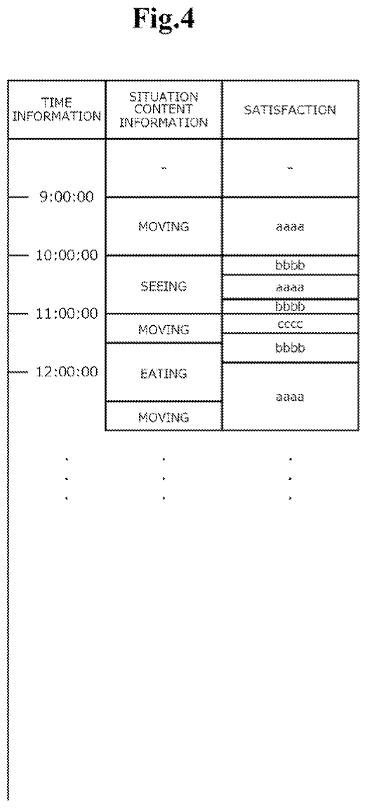

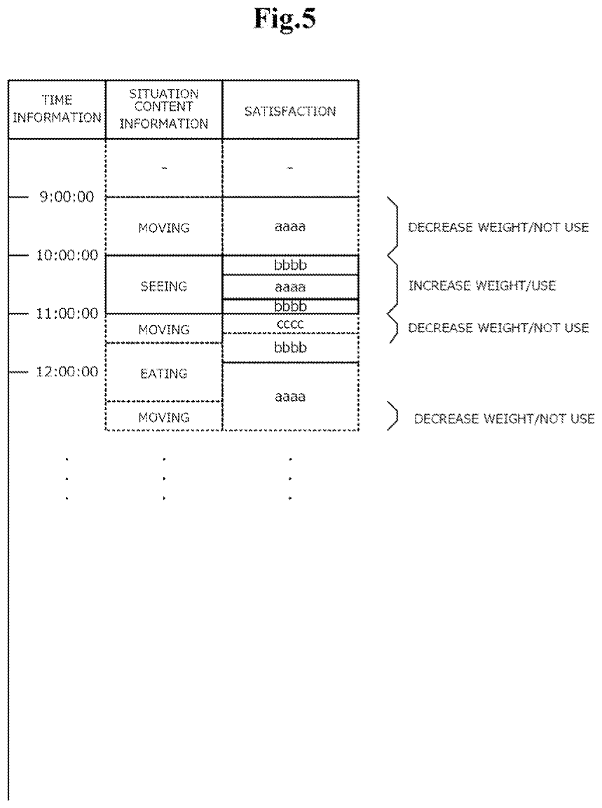

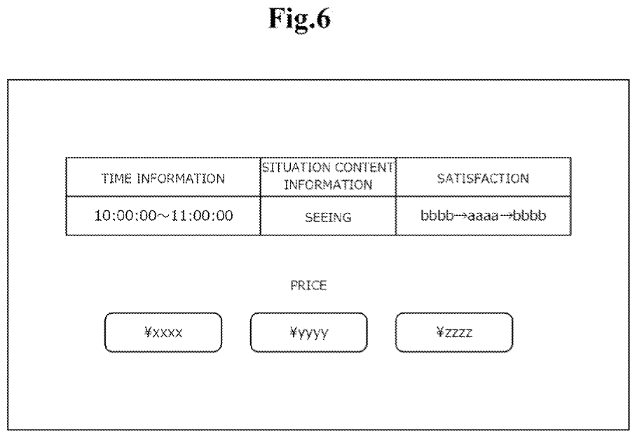

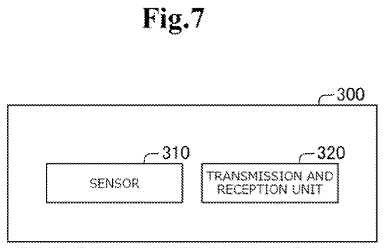

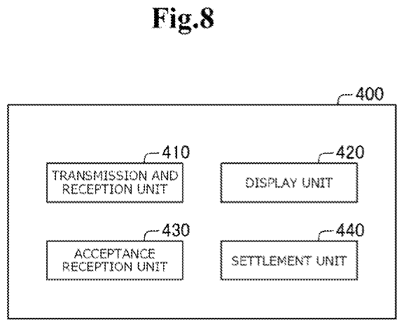

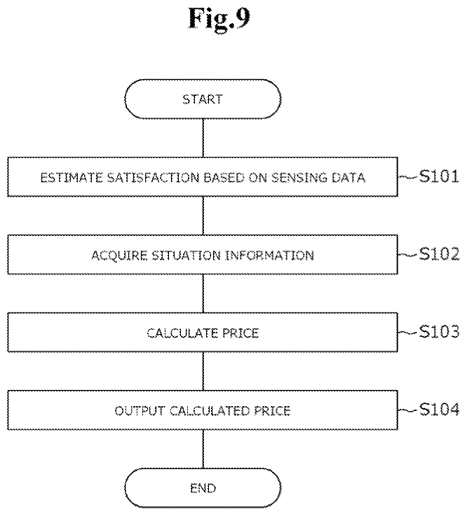

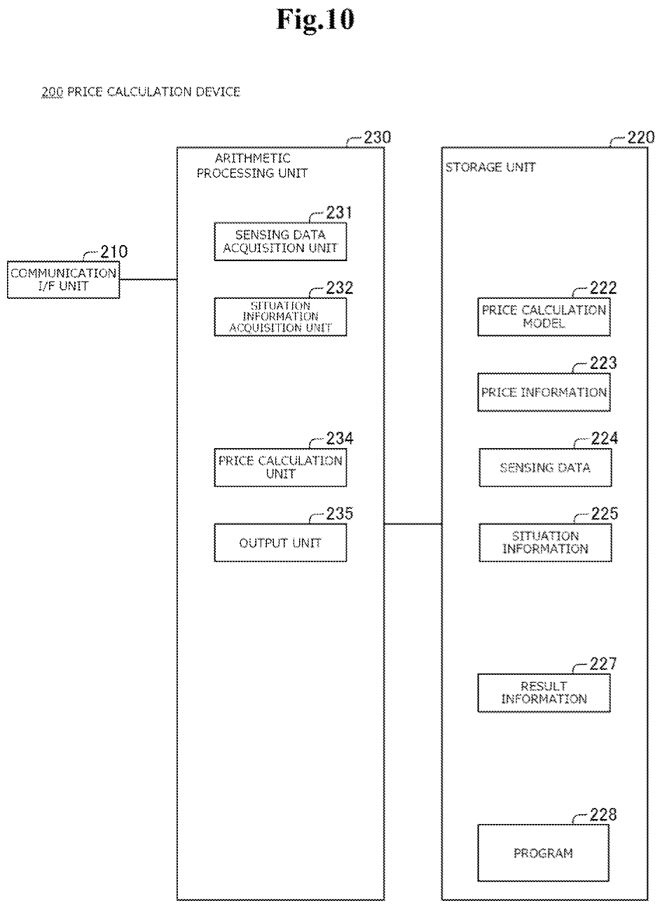

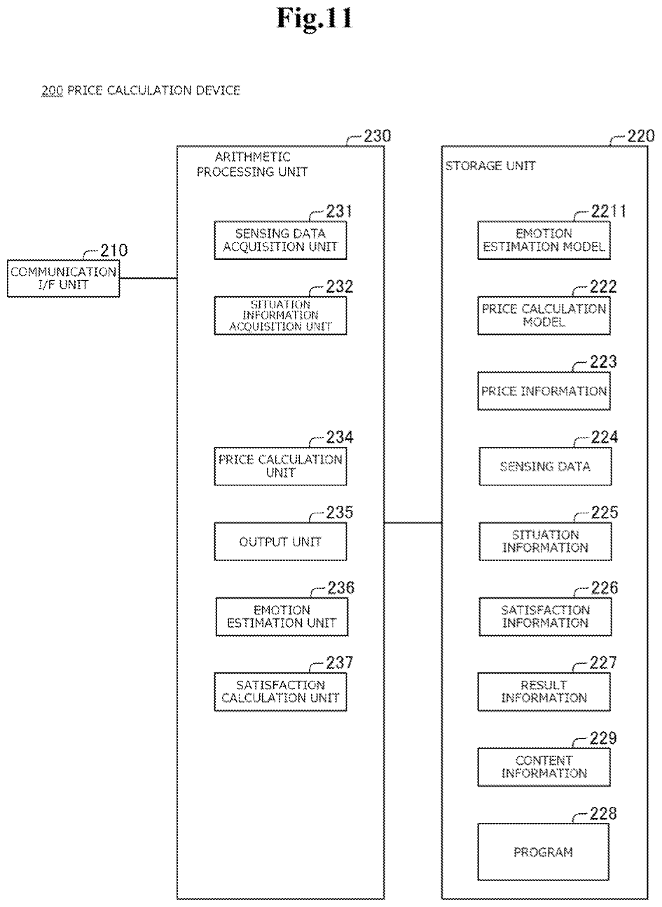

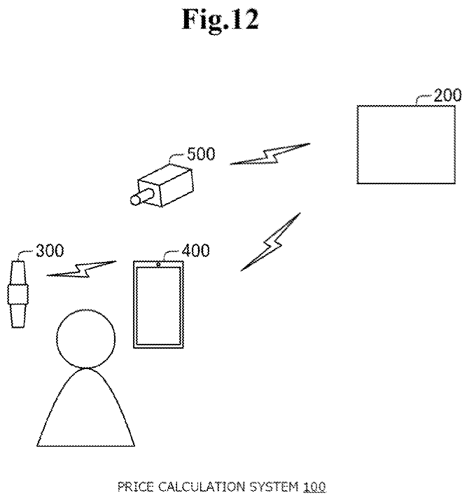

A first exemplary embodiment of the present disclosure will be described with reference to FIGS. 1 to 12. FIG. 1 illustrates an exemplary configuration of a price calculation system 100. FIG. 2 is a block diagram illustrating an exemplary configuration of a price calculation device 200. FIG. 3 is a diagram for explaining an example of situation information 225. FIG. 4 is a diagram for explaining an example of satisfaction information 226. FIG. 5 is a diagram for explaining exemplary processing performed by a price estimation unit 234. FIG. 6 is a diagram illustrating an exemplary output by an output unit 235. FIG. 7 is a block diagram illustrating an exemplary configuration of a wearable sensor 300. FIG. 8 is a block diagram illustrating an exemplary configuration of a smartphone 400. FIG. 9 is a flowchart illustrating an exemplary operation of the price calculation device 200. FIGS. 10 and 11 are block diagrams illustrating other exemplary configurations of the price calculation device 200. FIG. 12 illustrates another exemplary configuration of the price calculation system 100.

In the first exemplary embodiment of the present disclosure, the price calculation system 100 for calculating the price of a service provided to a user will be described. As described below, the price calculation system 100 acquires information representing the condition of a user such as time-series data sensed by a wearable sensor 300 when the user is receiving a service, and information representing the situation of the user who is receiving the service. Then, the price calculation system 100 determines the price on the basis of the information representing the condition of the user and the information representing the situation. For example, the price calculation system 100 estimates the satisfaction of the user with respect to the service on the basis of the information representing the condition of the user. Then, the price calculation system 100 calculates the price of the service on the basis of the estimated satisfaction, and a weight corresponding to the information representing the situation of the user.

Note that the services for which prices are calculated by the price calculation system 100 include services that take some time such as a meal service in a restaurant, a trip such as visiting a temple or a hot spring, hotel accommodation, viewing of a live or a movie, an online school such as yoga or a lecture for students, for example. The price calculation system 100 may determine the price of a service other than those mentioned above as examples.

FIG. 1 illustrates an exemplary configuration of the price calculation system 100. Referring to FIG. 1, the price calculation system 100 includes a price calculation device 200, a wearable sensor 300, and a smartphone 400. For example, in the case of FIG. 1, the wearable sensor 300 is put on an arm or elsewhere of a user who receives a service, and the user has the smartphone 400. As illustrated in FIG. 1, the wearable sensor 300 and the smartphone 400 are communicably connected to each other by using a short range radio such as Bluetooth (registered trademark) for example. Further, the smartphone 400 and the price calculation device 200 are communicably connected to each other by using WiFi (registered trademark) or a wireless communication such as 4G or 5G.

The price calculation device 200 is an information processing device that calculates the price of a service provided to a user, with use of data sensed by the wearable sensor 300. FIG. 2 illustrates an exemplary configuration of the price calculation device 200. Referring to FIG. 2, the price calculation device 200 includes a communication I/F unit 210, a storage unit 220, and an arithmetic processing unit 230, as main constituent elements.

The communication I/F unit 210 is configured of a data communication circuit. The communication I/F unit 210 performs data communication with the smartphone 400 and other external devices connected thereto.

The storage unit 220 is a storage device such as a hard disk or a memory. The storage unit 220 stores therein processing information and a program 228 required for various types of processing performed in the arithmetic processing unit 230. The program 228 is read and executed by the arithmetic processing unit 230 to thereby implement various processing units. The program 228 is read in advance from an external device or a storage medium via a data input/output function of the communication I/F unit 210 or the like, and is stored in the storage unit 220. The main information to be stored in the storage unit 220 includes, for example, a satisfaction estimation model 221, a price calculation model 222, price information 223, sensing data 224, situation information 225, satisfaction information 226, and result information 227.

The satisfaction estimation model 221 is a learned model to be used for estimating the satisfaction representing whether or not a user who is receiving a service is satisfied with the service, on the basis of data sensed by the wearable sensor 300. For example, the satisfaction estimation model 221 receives information corresponding to the data represented by the sensing data 224, and outputs satisfaction. The satisfaction estimation model 221 is generated in advance through machine learning using a neural network in an external device, for example. For example, the satisfaction estimation model 221 is acquired from an external device via the communication I/F unit 210 or the like, and is stored in the storage unit 220.

Note that information to be input to the satisfaction estimation model 221 may be data itself represented by the sensing data 224, or data calculated based on the sensed data. For example, in the case of the present embodiment, the sensing data 224 represents the pulse rate of a user at each clock time, as described below. In that case, the information to be input to the satisfaction estimation model 221 may be, for example, the pulse rate itself, a pulse peak interval (PPI) of a pulse wave that is calculated on the basis of the pulse rate, or various types of feature amounts such as an average, a standard deviation, a coefficient variation, a route-mean square, and a frequency component, calculated by performing heart rate variability analysis by cutting out the PPI for each predetermined range.

The satisfaction estimated by using the satisfaction estimation model 221 may be an index corresponding to the emotion according to the type of a service. For example, the satisfaction includes those corresponding to the type of a service provided to the user and the emotion corresponding to the type of the service such as a degree of scare in a haunted house, a degree of laughing at a comedy live, or a degree of stress relief (degree of relax) at esthetic or massage.

The price calculation model 222 is a learned model to be used for calculating the price on the basis of the satisfaction output by using the satisfaction estimation model 221. For example, the price calculation model 222 outputs a price that is a value of a service received by the user, by using the satisfaction, the price information 223, and a weight corresponding to the situation of the user represented by the situation information 225 as inputs. Note that the price calculation model 222 may output one price or a plurality of prices such as three prices. The price calculation model 222 is generated in advance through machine learning using a neural network in an external device, for example. For example, the price calculation model 222 is acquired from an external device via the communication I/F unit 210 or the like, and is stored in the storage unit 220.

The price information 223 includes information representing the list price of a service. For example, in the price information 223, identification information for identifying a service and a list price of the service are associated with each other. Note that the price information 223 may include information other than that representing a list price, such as a minimum price representing the lowest price estimated by the price calculation unit 234 or a maximum price that is the highest price.

The sensing data 224 includes time-series data sensed by the wearable sensor 300 during the time that the user is receiving a service. For example, in the case of the present embodiment, the wearable sensor 300 senses the pulse rate of a user as information representing the condition of the user who is receiving a service. Therefore, in the sensing data 224, data representing the heart rate of the user sensed by the wearable sensor 300 and time information representing the sensing clock time are associated with each other. Note that the sensing data 224 is data corresponding to the data sensed by the wearable sensor 300. Therefore, for example, when the wearable sensor 300 senses the sweat rate of a user as information representing the condition of the user, the sensing data 224 includes data representing the sweat rate. The sensing data 224 may include data corresponding to the data sensed by the wearable sensor 300, other than that described above as an example.

The situation information 225 includes information representing the situation of a user who is receiving a service. For example, the situation information 225 includes information representing the action at each clock time of a user who is receiving a service. FIG. 3 illustrates an example of the situation information 225. Referring to FIG. 3, in the situation information 225, for example, time information representing the clock time and situation content information representing the situation of the user are associated with each other. For example, the first row of FIG. 3 shows that during “9:00:00 to 10:00:00”, the situation of the user who is receiving the service is “ααααα”.

Here, the situation content information is information representing the situation of the user and the action of the user at the corresponding time. For example, the situation content information representing a situation of the user at the corresponding time according to a service received by the user, such as “moving”, “seeing” “waiting for a meal”, “eating”, “viewing”, “listening to an explanation by an instructor”, and “doing yoga”. Note that the situation content information may represent a subdivided situation or a detailed action such as “observing a XX part of the facility”, “viewing a chapter 00”, or “doing yoga ZZ pose”. Moreover, the situation content information may include information other than that described above as an example. For example, the situation content information may include information representing the position of the user as information representing the action of the user.

The satisfaction information 226 represents satisfaction of the user at each clock time estimated by using the satisfaction estimation model 221. In the satisfaction information 226, for example, time information representing the clock time and the information representing the satisfaction of the user are associated with each other.

As illustrated in FIG. 4, the satisfaction information 226 may be stored in the storage unit 220 in association with the situation content information represented by the situation information 225. As illustrated in FIGS. 3 and 4, in the situation information 225, the time information and the situation content information are associated with each other. Therefore, it can be said that the satisfaction information 226 represents the satisfaction of the user in each scene of the user represented by the situation content information.

The result information 227 includes information representing the price calculated by the price calculation unit 234, information representing the price determined by the user as a result of output by the output unit 235, and the like. As described below, the information included in the result information 227 can be used for calculating the price by the price calculation unit 234.

The arithmetic processing unit 230 includes a microprocessor such as an MPU and the peripheral circuits thereof. The arithmetic processing unit 230 reads and executes the program 228 from the storage unit 220 to implement various processing units by the cooperation of the hardware and the program 228. Main processing units to be implemented by the arithmetic processing unit 230 include, for example, a sensing data acquisition unit 231, a situation information acquisition unit 232, a satisfaction estimation unit 233, a price calculation unit 234, and an output unit 235.

The sensing data acquisition unit 231 acquires data sensed by the wearable sensor 300 from the smartphone 400 via the communication I/F unit 210. For example, the sensing data acquisition unit 231 acquires data representing the pulse rate sensed by the wearable sensor 300 from the smartphone 400. Then, the sensing data acquisition unit 231 stores the acquired data in the storage unit 220 as the sensing data 224 in association with the acquired date/time (information representing the time) of the data for example.

The situation information acquisition unit 232 acquires information representing the situation of a user who is receiving a service. For example, the situation information acquisition unit 232 acquires information corresponding to the action of the user as information representing the situation of the user who is receiving the service. Then, the situation information acquisition unit 232 stores the acquired information in the storage unit 220 as the situation information 225.

For example, the situation information acquisition unit 232 can acquire information representing the situation of the user by acquiring action plan information representing the action plan of the user. Specifically, for example, the situation information acquisition unit 232 acquires schedule information showing the action plan of the user from a scheduler of an external device held by a service provider, via the communication I/F unit 210. Here, schedule information is information in which time information and information representing a situation of the user planned at the time represented by the time information are associated with each other. For example, the schedule information shows a situation of the user at each time such that in “10:00:00 to 11:00:00”, the user is “seeing”, in “17:30:00 to 18:30:00”, the user is “eating”, in “10:10:00 to 10:15:30”, the user is “seeing a XX part of the facility”, and “from the start of the service until 15 minutes have passed”, the user is “listening to a lecture by an instructor”, or the like.

Further, the situation information acquisition unit 232 can acquire information representing the situation of the user on the basis of the position information of the user and image data acquired by an external monitoring camera or the like. For example, on the basis of the position information of the user, the situation information acquisition unit 232 can acquire information representing a situation of “seeing” when the user is located around a part worth seeing that is set previously, and “moving” when the user is located between a part worth seeing and another part that are set previously. Further, the situation information acquisition unit 232 can acquire information representing the situation of the user corresponding to the action of the user such that the user is “seeing” or “eating”, on the basis of image data acquired by an external monitoring camera or the like.

Note that the situation information acquisition unit 232 may acquire information representing the situation of the user by means of a method other than that illustrated above as an example. For example, the situation information acquisition unit 232 may acquire information representing the situation of the user according to the download state of a digital content to be viewed, an input from the instructor, or the like. The situation information acquisition unit 232 may acquire information representing the situation of the user by combining the methods illustrated above as examples. For example, after acquiring the schedule information, the situation information acquisition unit 232 may revise and update the situation of the user on the basis of the position information of the user.

The satisfaction estimation unit 233 estimates the satisfaction of a user at each time by using the satisfaction estimation model 221. For example, the satisfaction estimation unit 233 acquires data sensed by the wearable sensor 300 with reference to the sensing data 224. Then, the satisfaction estimation unit 233 estimates the satisfaction of the user at each time by inputting the acquired data into the satisfaction estimation model 221. Then, the satisfaction estimation unit 233 stores the information representing the estimated satisfaction in the storage unit 220 as the satisfaction information 226.

As described above, the satisfaction estimation unit 233 may be configured to calculate the PPI or various feature amounts on the basis of the acquired data, and input the calculated PPI or various feature amounts in the satisfaction estimation model 221.

The price calculation unit 234 calculates the price of a service received by a user by using the price calculation model 222. For example, the price calculation unit 234 calculates the price of a service by inputting the satisfaction estimated by the satisfaction estimation unit 233, a weight according to the situation of the user at each time, and a list price represented by the price information 223 into the price calculation model 222. Then, the price calculation unit 234 stores the information representing the calculated price in the storage unit 220 as the result information 227.

Here, a weight according to the situation of a user is, for example, a value previously defined according to whether or not the situation is directly related to the service. For example, regarding the weight according to the situation of a user, the value is larger as the situation is largely related to the service or it is desirable to place a higher importance in the service such as “seeing” when the service is “temple tour”, “eating” in the case of “providing a meal at a restaurant”, or “doing yoga” when the service is “yoga online lesson”. Meanwhile, regarding the weight according to the situation of a user, the value is smaller as the situation is less related to the service or it is not so important such as “moving” when the service is “temple tour”, “waiting for a meal” in the case of “providing a meal at a restaurant”, or “listening to a lecture by an instructor” when the service is “yoga online lesson”. Note that the weight value may be one other than that illustrated above as an example. For example, the weight value may be determined in a subdivided manner such that the value may be different depending on the seeing object although the situation is the same “seeing”. Further, the weight value may be revised as appropriate.

FIG. 5 illustrates an example of a weight given by the price calculation unit 234 when the service is “temple tour”. Referring to FIG. 5, for example, the price calculation unit 234 decreases the wright value at the time corresponding to a situation determined to have a less direct relation with the service such as the situation content information being “moving”. On the other hand, the price calculation unit 234 increases the wright value at the time corresponding to a situation determined to have a relation with the service such as the situation content information being “seeing”. As described above, the price calculation unit 234 sets the weight value on the basis of the situation content information and the content of the service received by the user. Then, the price calculation unit 234 inputs the set weight into the price calculation model 222.

Note that the price calculation unit 234 can revise the calculated price on the basis of the result information 227. For example, on the basis of the result information 227, when a predetermined condition is satisfied such as the case where the number of times that the lowest price among three output prices is selected is a predetermined value or larger, the price calculation unit 234 can revise the three prices so that the lowest price in the calculated prices becomes the intermediate price. In other words, after calculation of the price based on the price calculation model 222, the price calculation unit 234 may revise the calculated price according to the tendency of the user represented by the result information 227.

The output unit 235 outputs information representing the price calculated by the price calculation unit 234. For example, the output unit 235 outputs information representing the price calculated by the price calculation unit 234 to the smartphone 400.

FIG. 6 illustrates an example of information output by the output unit 235. Referring to FIG. 6, the output unit 235 outputs information representing the prices calculated by the price calculation unit 234 such as ¥xxxx, ¥yyyy, and ¥zzzz, and information serving as the basis for price calculation. Further, in the case of FIG. 6, as the information serving as the basis for price calculation, the output unit 235 outputs the clock time, the situation content information, and the satisfaction information in association with one another. Note that the number of prices to be output by the output unit 235 corresponds to the number of prices calculated by the price calculation unit 234. The output unit 235 may output information other than that illustrated above as an example.

Moreover, in the case of outputting a plurality of prices as illustrated in FIG. 6, the output unit 235 can acquire information representing the price selected by the user among the prices output from the smartphone 400. In that case, the output unit 235 stores the information representing the acquired price in the storage unit 220 as the result information 227.

The exemplary configuration of the price calculation device 200 is as described above.

The wearable sensor 300 is a sensing device such as a smart watch that is worn by a user and senses information representing the condition of the user. In the case of the present embodiment, the wearable sensor 300 senses the heart rate of a user as information representing the condition of the user, as described above. FIG. 7 illustrates an exemplary configuration of the wearable sensor 300. Referring to FIG. 7, the wearable sensor 300 has functions as a sensor 310 and a transmission and reception unit 320, for example. Note that the function as the wearable sensor 300 may be implemented by a hardware or may be implemented by execution of a program stored in the storage device by the arithmetic unit, for example.

The sensor 310 senses information representing the condition of the user. For example, the sensor 310 senses the heart rate of the user as information representing the condition of the user. The sensor 310 may sense data other than that illustrated above as an example, such as a sweat rate of a palm.

The transmission and reception unit 320 has an antenna and the like, and transmits data sensed by the sensor 310 to the smartphone 400. The transmission and reception unit 320 may transmit data other than that sensed by the sensor 310 to the smartphone 400, such as information representing the sensing time in addition to the data sensed by the sensor 310.

The smartphone 400 is an information processing device that transmits data received from the wearable sensor 300 to the price calculation device 200. FIG. 8 illustrates an exemplary configuration of the smartphone 400. Referring to FIG. 8, the smartphone 400 includes typical functions held by a smartphone such as a GPS for acquiring position information and a screen display unit with a touch panel, and also includes a transmission and reception unit 410, a display unit 420, an acceptance reception unit 430, and a settlement unit 440. Note that the function as the smartphone 400 may be implemented by a hardware or may be implemented by execution of a program stored in the storage device by the arithmetic unit, for example.

The transmission and reception unit 410 has an antenna and the like, and receives, from the wearable sensor 300, data sensed by the wearable sensor 300. Then, the transmission and reception unit 410 transmits the received data to the price calculation device 200. The transmission and reception unit 410 also receives, from the price calculation device 200, information output by the output unit 235. Moreover, in the case where the price calculation device 200 calculates a plurality of prices, the transmission and reception unit 410 transmits the price that the acceptance reception unit 430 receives the user's acceptance, to the price calculation device 200 as information representing the price selected by the user. Note that the transmission and reception unit 410 may transmit information other than illustrated above as an example such as information representing the position of the smartphone 400 to the price calculation device 200.

When the transmission and reception unit 410 receives information output by the output unit 235, the display unit 420 displays the received information on the screen display unit with a touch panel or the like. For example, as illustrated in FIG. 6, the display unit 420 displays, on the screen, information representing the price calculated by the price calculation unit 234 and the information serving as the basis for price calculation.

The acceptance reception unit 430 acquires information representing the price accepted by the user in response to a user's touch to a price shown on the screen display unit with a touch panel. For example, when a plurality of prices are shown, the acceptance reception unit 430 acquires information representing which price is accepted by the user. As described above, the price that the acceptance reception unit 430 receives the user's acceptance can be transmitted to the price calculation device 200 as information representing the price selected by the user.

The settlement unit 440 makes a settlement at the price received by the acceptance reception unit 430. The settlement process executed by the settlement unit 440 may be realized by means of a previously known technique.

The exemplary configuration of the price calculation system 100 is as described above. Next, an exemplary operation of the price calculation device 200 will be described with reference to FIG. 9.

FIG. 9 illustrates an exemplary operation of the price calculation device 200. Referring to FIG. 9, the satisfaction estimation unit 233 estimates the satisfaction of a user at each time by using the satisfaction estimation model 221 (step S101). For example, the satisfaction estimation unit 233 acquires data sensed by the wearable sensor 300 with reference to the sensing data 224. Then, the satisfaction estimation unit 233 inputs the acquired data to the satisfaction estimation model 221 and estimates the satisfaction of the user at each time.

Note that the satisfaction estimation unit 233 may be configured to calculate a PPI or various feature amounts on the basis of the acquired data, and input the calculated PPI or various feature amounts in the satisfaction estimation model 221.

The price calculation unit 234 acquires the satisfaction estimated by the satisfaction estimation unit 233. The price calculation unit 334 also acquires information representing the situation of the user with reference to the situation information 225 (step S102). The price calculation unit 234 also acquires information representing the list price of the service with reference to the price information 234.

The price calculation unit 234 calculates the price of the service received by the user by using the price calculation model 222 (step S103). For example, the price calculation unit 234 calculates the price of the service by inputting the satisfaction estimated by the satisfaction estimation unit 233, a weight corresponding to the situation of the user at each time, and a list price represented by the price information 223, into the price calculation model 222.

The output unit 235 outputs information representing the price calculated by the price calculation unit 234. For example, the output unit 235 outputs information representing the price calculated by the price calculation unit 234 to the smartphone 400 (step S104). The output unit 235 can output information representing the price and information serving as the basis for price calculation.

The exemplary operation of the price calculation device 200 is as described above.

As described above, the price calculation device 200 includes the situation information acquisition unit 232, the satisfaction estimation unit 233, and the price calculation unit 234. With this configuration, the price calculation unit 234 can calculate the price of a service on the basis of the satisfaction estimated by the satisfaction estimation unit 233 and a weight corresponding to the situation of the user at each time. As a result, it is possible to calculate the price on the basis of the satisfaction in consideration of the situation of the user. Thereby, it is possible to improve the accuracy of satisfaction estimation and to perform more accurate price estimation.

In the present embodiment, an exemplary configuration of the price calculation device 200 has been described with reference to FIG. 2 and the like. However, the price calculation device 200 is not limited to have the configuration illustrated in FIG. 2.

FIG. 10 illustrates another exemplary configuration of the price calculation device 200. FIG. 10 illustrates an exemplary configuration of the price calculation device 200 that calculates the price of a service by inputting, into the price calculation model 222, data sensed by the wearable sensor 300, a weight corresponding to the situation of the user at each time, and a list price represented by the price information 223, without performing estimation of the satisfaction using the satisfaction estimation model 221. As illustrated in FIG. 10, in the case of inputting data sensed by the wearable sensor 300 into the price calculation model 222, the price calculation device 200 may not include the satisfaction estimation unit 233. Further, the storage unit 220 may not store therein the satisfaction estimation model 221 and the satisfaction information 226. In the case of the configuration illustrated in FIG. 10, the price estimation model 222 receives data sensed by the wearable sensor 300 as an input instead of satisfaction, and outputs the price.

Further, the price calculation device 200 may have a configuration as illustrated in FIG. 11. In the case of FIG. 11, the price calculation device 200 includes an emotion estimation unit 236 and a satisfaction calculation unit 237, instead of the satisfaction estimation unit 233. Further, in the storage unit 220, an emotion estimation model 2211 is stored instead of the satisfaction estimation model 221, and the storage unit 220 can store therein content information 229.

The emotion estimation model 2211 is a learned model to be used for estimating emotion of a user who is receiving a service, on the basis of data sensed by the wearable sensor 300. For example, the emotion estimation model 2211 receives information corresponding to the data represented by the sensing data 224 as an input, and outputs information used for determining the emotion of the user. For example, the emotion estimation model 2211 receives information corresponding to the data represented by the sensing data 224 as an input, and output information representing valence and arousal. The emotion estimation model 2211 is generated in advance through machine learning using a neural network in an external device or the like, for example. For example, the emotion estimation model 2211 is acquired from an external device via the communication I/F unit 210 or the like, and is stored in the storage unit 220.

Note that information to be input to the emotion estimation model 2211 may be data itself represented by the sensing data 224, or data calculated based on the sensed data. For example, the information to be input to the emotion estimation model 2211 may be the pulse rate itself, a pulse peak interval (PPI) of a pulse wave that is calculated on the basis of the pulse rate, or various feature amounts such as an average, a standard deviation, a coefficient variation, and a frequency component, calculated by performing heart rate variability analysis by cutting out the PPI for each predetermined range.

The content information 229 includes information in which the type of a service and the emotion corresponding to the type of the service are associated with each other. For example, in the case where the service is “amusement park visit”, the facilities to be visited and played include various attractions such as “haunted house”, “Ferris wheel”, and “merry-go-round”. Further, in the case of “yoga online school”, poses to be taken in the school include various poses. As described above, a service can be subdivided. The content information 229 may be associated with emotion corresponding to the entire service or may be associated with emotion corresponding to a subdivided service.

The emotion estimation unit 236 estimates the emotion of a user at each time by using the emotion estimation model 2211. For example, the emotion estimation unit 236 acquires data sensed by the wearable sensor 300 with reference to the sensing data 224. Then, the emotion estimation unit 236 inputs the acquired data into the emotion estimation model 2211, and outputs information representing the valence and the arousal that is information used for determining the emotion of the user at each time. Further, the emotion estimation unit 236 estimates the emotion of the user by determining the quadrant position in the Russell's Circumplex Model, from the estimated valence and arousal. For example, the emotion estimation unit 236 estimates emotion such as anger, joy, sadness, or relax.

As described above, the emotion estimation unit 236 may be configured to calculate a PPI or various feature amounts on the basis of the acquired data, and input the calculated PPI or various feature amounts in the satisfaction estimation model 221.

The satisfaction calculation unit 237 calculates the satisfaction of the user on the basis of the emotion estimated by the emotion estimation unit 236 and the content information 229. For example, the satisfaction calculation unit 237 calculates the satisfaction of the user on the basis of whether or not the emotion estimated by the emotion estimation unit 236 and the emotion represented by the content information 229 are the same, and whether or not the difference is allowable. For example, the satisfaction calculation unit 237 can calculate the satisfaction representing that the user is satisfied when the emotion estimated by the emotion estimation unit 236 and the emotion represented by the content information 229 are the same or when the difference in the emotion is within a predetermined allowable range. The satisfaction calculation unit 237 may calculate the satisfaction while considering the time in which the emotion estimated by the emotion estimation unit 236 and the emotion represented by the content information 229 are the same, for example. The satisfaction calculation unit 237 may also be configured to calculate the satisfaction based on the estimated emotion by using a model having been learned in advance.

For example, the price calculation device 200 may adopt various modifications as described above.

Further, the price calculation system 100 can include a constituent element other than the price calculation device 200, the wearable sensor 300, and the smartphone 400. FIG. 12 illustrates another exemplary configuration of the price calculation system 100. Referring to FIG. 12, the price calculation system 100 includes a camera 500 in addition to the price calculation device 200, the wearable sensor 300, and the smartphone 400.

The camera 500 acquires image data by capturing an image of a state of a user. In the price calculation device 200, the image data acquired by the camera 500 is used for determining the situation of the user, and can also be used for determining the condition of the user. For example, the price calculation device 200 can determine the condition of the user on the basis of face expression of the user determined based on the image data. As described above, the condition of the user may be determined based on that other than data sensed by the wearable sensor 300, or by utilizing that other than data sensed by the wearable sensor 300. For example, the price calculation device 200 can perform determination on the basis of voice information of a user acquired using a microphone held by the price calculation system.

In the present embodiment, description has been given on the case where the function as the price calculation device 200 is realized by one information processing device. However, the function as the price calculation device 200 may be realized by a plurality of information processing devices connected over a network, for example. In other words, the function as the price calculation device 200 may be realized by using cloud computing.

### Second Exemplary Embodiment

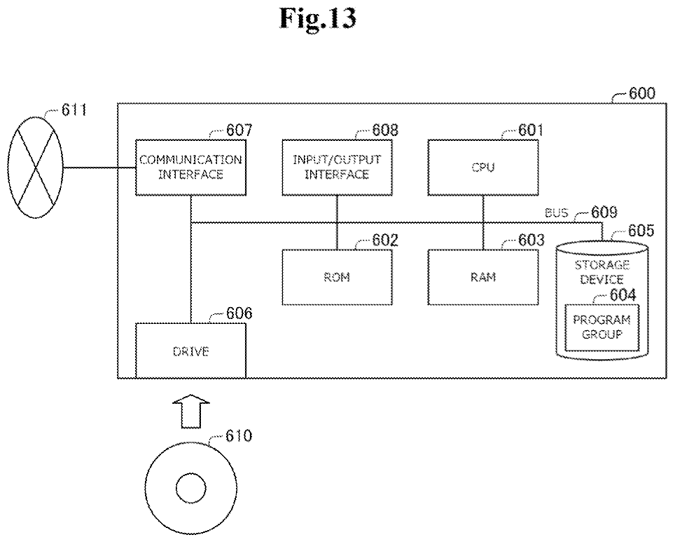

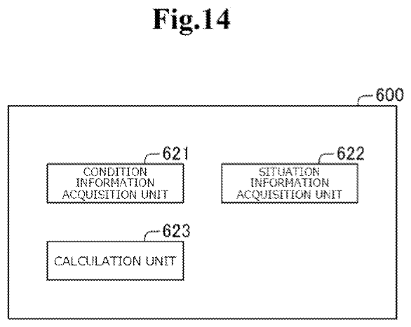

Next, a second exemplary embodiment of the present invention will be described with reference to FIGS. 13 and 14. FIGS. 13 and 14 illustrate an exemplary configuration of a price calculation device 600.

FIG. 13 illustrates an exemplary hardware configuration of the price calculation device 600. Referring to FIG. 13, the price calculation device 600 includes a hardware configuration as described below, as an example.

Central Processing Unit (CPU) 601 (arithmetic device)

Read Only Memory (ROM) 602 (storage device)

Random Access Memory (RAM) 603 (storage device)

Program group 604 to be loaded to the RAM 603

Storage device 605 storing therein the program group 604

Drive 606 that performs reading and writing on a storage medium 610 outside the information processing device

Communication interface 607 connecting to a communication network 611 outside the information processing device

Input/output interface 608 for performing input/output of data

Bus 609 connecting the respective constituent elements

Further, the price calculation device 600 can realize functions as a condition information acquisition unit 621, a situation information acquisition unit 622, and a calculation unit 623 illustrated in FIG. 14 through acquisition and execution of the program group 604 by the CPU 601. Note that the program group 604 is stored in the storage device 605 or the ROM 602 in advance, and is loaded to the RAM 603 by the CPU 601 as needed. Further, the program group 604 may be provided to the CPU 601 via the communication network 611, or may be stored on a storage medium 610 in advance and read out by the drive 606 and supplied to the CPU 601.

FIG. 13 illustrates an exemplary hardware configuration of the price calculation device 600. The hardware configuration of the price calculation device 600 is not limited to that described above. For example, the price calculation device 600 may be configured of part of the configuration described above, such as without the drive 606.

The condition information acquisition unit 621 acquires condition information representing the condition of a user who is receiving a service. For example, the condition information acquisition unit 621 can acquire data acquired by a sensor put on the user, such as the heart rate, as condition information.

The situation information acquisition unit 622 acquires situation information representing the situation of a user. For example, the situation information acquisition unit 622 acquires information corresponding to the action taken by a user as situation information representing the situation of the user.

The calculation unit 623 calculates the price of a service on the basis of the condition information acquired by the condition information acquisition unit 621 and the situation information acquired by the situation information acquisition unit 622.

As described above, the price calculation device 600 includes the condition information acquisition unit 621, the situation information acquisition unit 622, and the calculation unit 623. With this configuration, the calculation unit 623 can calculate the price of a service on the basis of the condition information and the situation information. As a result, it is possible to calculate the price while considering the situation of a user, and to perform more appropriate price estimation.

Note that the price calculation device 600 described above can be realized by incorporation of a predetermined program in the price calculation device 600. Specifically, a program that is another aspect of the present invention is a program for implementing, on the price calculation device 600, the condition information acquisition unit 621 that acquires condition information representing the condition of a user who is receiving a service, the situation information acquisition unit 622 that acquires situation information representing the situation of the user, and the calculation unit 623 that calculates the price of the service on the basis of the condition information acquired by the condition information acquisition unit 621 and the situation information acquired by the situation information acquisition unit 622.

Further, a price calculation method to be executed by the price calculation device 600 is a method including, by the price calculation device 600, acquiring condition information representing the condition of a user who is receiving a service, acquiring situation information representing the situation of the user, and calculating the price of the service on the basis of the acquired condition information and the acquired situation information.

Since an invention of a program (storage medium storing thereon a program) or a price calculation method, having the above-described configuration, exhibits the same actions and effects as those of the price calculation device 600, the above-described object of the present invention can be achieved by such an invention.

### SUPPLEMENTARY NOTES

The whole or part of the exemplary embodiments disclosed above can be described as the following supplementary notes. Hereinafter, the outlines of a price calculation device and the like of the present invention will be described. However, the present invention is not limited to the configurations described below.

### (Supplementary Note 1)

A price calculation device comprising:

a condition information acquisition unit that acquires condition information representing a condition of a user who is receiving a service;

a situation information acquisition unit that acquires situation information representing a situation of the user; and

a calculation unit that calculates a price of the service on a basis of the condition information acquired by the condition information acquisition unit and the situation information acquired by the situation information acquisition unit.

### (Supplementary Note 2)

The price calculation device according to supplementary note 1, wherein

the situation information acquisition unit acquires information corresponding to an action being taken by the user, as the situation information.

### (Supplementary Note 3)

The price calculation device according to supplementary note 1 or 2, wherein

the situation information acquisition unit acquires action plan information representing an action plan of the user, as the situation information.

### (Supplementary Note 4)

The price calculation device according to any of supplementary notes 1 to 3, wherein

the situation information acquisition unit acquires position information representing a position of the user, as the situation information.

### (Supplementary Note 5)

The price calculation device according to any of supplementary notes 1 to 4, wherein

the condition information acquisition unit acquires data sensed by a sensor put on the user, as the condition information.

### (Supplementary Note 6)

The price calculation device according to supplementary note 5, wherein

the condition information acquisition unit acquires information corresponding to a pulse rate of the user, as the condition information.

### (Supplementary Note 7)

The price calculation device according to any of supplementary notes 1 to 6, further comprising

an estimation unit that estimates information representing satisfaction of the user with respect to the service, on a basis of the condition information acquired by the condition information acquisition unit, wherein

the calculation unit calculates the price of the service on a basis of the satisfaction estimated by the estimation unit and the situation information acquired by the situation information acquisition unit.

### (Supplementary Note 8)

The price calculation device according to supplementary note 7, wherein

the estimation unit estimates the satisfaction by using a satisfaction estimation model that outputs the satisfaction of the user corresponding to an input of the condition information.

### (Supplementary Note 9)

The price calculation device according to any of supplementary notes 1 to 8, wherein

the calculation unit calculates the price of the service by using a price calculation model that outputs the price of the service corresponding to an input including a weight according to the situation information.

### (Supplementary Note 10)

The price calculation device according to any of supplementary notes 1 to 9, wherein

the calculation unit outputs information representing a plurality of prices as the price of the service.

### (Supplementary Note 11)

The price calculation device according to supplementary note 10, wherein

the calculation unit revises the price of the service calculated by the calculation unit on a basis of result information representing a selection result of the user with respect to a result calculated by the calculation unit.

### (Supplementary Note 12)

A price calculation method comprising, by a price calculation device:

acquiring condition information representing a condition of a user who is receiving a service;

acquiring situation information representing a situation of the user; and

calculating a price of the service on a basis of the acquired condition information and the acquired situation information.

### (Supplementary Note 13)

A computer-readable medium storing thereon a program for implementing, on a price calculation device:

a condition information acquisition unit that acquires condition information representing a condition of a user who is receiving a service;

a situation information acquisition unit that acquires situation information representing a situation of the user; and

a calculation unit that calculates a price of the service on a basis of the condition information acquired by the condition information acquisition unit and the situation information acquired by the situation information acquisition unit.

It should be noted that the program described in the exemplary embodiments and the supplementary notes may be stored in a storage device or stored on a storage medium readable by a computer. The storage medium is a portable medium such as a flexible disk, an optical disk, a magneto-optical disk, or a semiconductor memory, for example.

While the present invention has been described with reference to the exemplary embodiments described above, the present invention is not limited to the above-described embodiments. The form and details of the present invention can be changed within the scope of the present invention in various manners that can be understood by those skilled in the art.

### REFERENCE SIGNS LIST

100 price calculation system
200 price calculation device
210 communication I/F unit
220 storage unit
221 satisfaction estimation model
222 price calculation model
223 price information
224 sensing data
225 situation information
226 satisfaction information
227 result information
228 program
229 content information
230 arithmetic processing unit
231 sensing data acquisition unit
232 situation information acquisition unit
233 satisfaction estimation unit
234 price calculation unit
235 output unit
236 emotion estimation unit
237 satisfaction calculation unit
300 wearable sensor
310 sensor
320 transmission and reception unit
400 smartphone
410 transmission and reception unit
420 display unit
430 acceptance reception unit
440 settlement unit
500 camera
600 price calculation device
601 CPU
602 ROM
603 RAM
604 program group
605 storage device
606 drive
607 communication interface
608 input/output interface
609 bus
610 storage medium
611 communication network
621 condition information acquisition unit
622 situation information acquisition unit
623 calculation unit

What is claimed is:

1. A price calculation device comprising:
at least one memory configured to store instructions; and
at least one processor configured to execute instructions to:
acquire condition information representing a condition of a user who is receiving a service;
acquire situation information representing a situation of the user; and
calculate a price of the service on a basis of the acquired condition information and the acquired situation information.

2. The price calculation device according to claim 1, wherein the at least one processor is configured to execute the instructions to
acquire information corresponding to an action being taken by the user, as the situation information.

3. The price calculation device according to claim 1, wherein the at least one processor is configured to execute the instructions to
acquire action plan information representing an action plan of the user, as the situation information.

4. The price calculation device according to claim 1, wherein the at least one processor is configured to execute the instructions to
acquire position information representing a position of the user, as the situation information.

5. The price calculation device according to claim 1, wherein the at least one processor is configured to execute the instructions to
acquire data sensed by a sensor put on the user, as the condition information.

6. The price calculation device according to claim 5, wherein the at least one processor is configured to execute the instructions to
acquire information corresponding to a pulse rate of the user, as the condition information.

7. The price calculation device according to claim 1, wherein the at least one processor is configured to execute the instructions to:
estimate information representing satisfaction of the user with respect to the service, on a basis of the condition information, and
calculate the price of the service on a basis of the estimated satisfaction and the situation information.

8. The price calculation device according to claim 7, wherein the at least one processor is configured to execute the instructions to
estimate the satisfaction by using a satisfaction estimation model that outputs the satisfaction of the user corresponding to an input of the condition information.

9. The price calculation device according to claim 1, wherein the at least one processor is configured to execute the instructions to
calculate the price of the service by using a price calculation model that outputs the price of the service corresponding to an input including a weight according to the situation information.

10. The price calculation device according to claim 1, wherein the at least one processor is configured to execute the instructions to
output information representing a plurality of prices as the price of the service.

11. The price calculation device according to claim 10, wherein the at least one processor is configured to execute the instructions to
revise the price of the service on a basis of result information representing a selection result of the user with respect to a calculated result.

12. A price calculation method comprising, by a price calculation device:
acquiring condition information representing a condition of a user who is receiving a service;
acquiring situation information representing a situation of the user; and
calculating a price of the service on a basis of the acquired condition information and the acquired situation information.

13. A non-transitory computer-readable medium storing thereon a program comprising instructions for causing a price calculation device to execute processing to:
acquire condition information representing a condition of a user who is receiving a service;
acquire situation information representing a situation of the user; and
calculate a price of the service on a basis of the acquired condition information and the acquired situation information.
